(19) United States
(12) Patent Application Publication
(10) Pub. No.: US 2007/0246495 A1
(43) Pub. Date: Oct. 25, 2007

(54) STORAGE SYSTEM FOR TRANSPORTING, PROTECTING AND STORING VALUABLE PROPERTY

(75) Inventor: Al Hague, Cusick, WA (US)

Correspondence Address: MILLER NASH LLP, 601 UNION STREET, SUITE4400, SEATTLE, WA, 98101-2352, US

(73) Assignee: Kalispel Case Line

(21) Appl. No.: 11/668,430

(22) Filed: Jan. 29, 2007

Related U.S. Application Data
(60) Provisional application No. 60/762,645, filed on Jan. 27, 2006.

(51) Int. Cl. B60R 7/00

(52) U.S. Cl. 224/281

(57) ABSTRACT

A storage system having a locking storage container which can be secured to a mounting surface, such as an automobile interior, for transporting, protecting and storing valuable property. The storage system is primarily intended for firearms, tools and similarly heavy items. At least one drawer is received within an interior chamber of the locking container, each drawer supported from below by several rollers housed within a container base pan. Each drawer can be independently locked with primary and redundant locks, including a remote-controlled self-arming lock that secures the back of each drawer in a location inaccessible to an unauthorized user. Anchor mounts are affixed on a mounting surface and engage the base pan in concealed locations under the container to minimize the risk of possible theft. An authorized user can unlock the drawer and remove it to access and disengage the anchor mounts, thereby removing and transporting storage container.

### CROSS-REFERENCE TO RELATED APPLICATION

This application claims benefit of U.S. Provisional Application Ser. No. 60/762,645 entitled Tactical Storage System, filed Jan. 27, 2006.

### FIELD OF INVENTION

The present invention relates to a storage system for transporting, protecting and storing valuable property. More specifically, the present invention is directed to a transportable locking storage system, which can be secured to an automobile, for protecting firearms and other valuable items.

### BACKGROUND OF THE INVENTION

Handguns, rifles, ammunition and other valuable and/or fragile property, as typically used by hunters, law enforcement and military personnel, are commonly transported by some form of automobile. For example, hunters and other recreational sportsmen and women transport guns and ammunition when traveling to and from a hunting site or firing range where their sport is to be conducted. Law enforcement and military personnel routinely carry guns and other tactical gear in their patrol cars and military vehicles.

The nature of most handguns, rifles and other tactical gear is that they can be extremely dangerous, particularly in the hands of unauthorized users. In addition to obvious safety concerns, firearms are oftentimes very expensive, and can represent a considerable loss to the owner should they be stolen or damaged. Responsible owners of firearms, and any other valuable property to be transported, usually take any available precautionary measures to help assure that their valuable property remains safely secured when not in use. This is particularly true when the valuable property is to be left unattended in an automobile or other vehicle.

Absent some way to secure their valuable property, owners sometimes simply locate it loosely in an automobile. For example, valuable property is often placed in a glove compartment or consol, or is located under the driver or passenger seat of the automobile in an attempt to conceal it. Glove compartments and consoles offer only a modest level of security, if they are capable of being locked at all, in that a determined thief needs only to defeat a first or second level of security to gain access to the contents within. Loose items may otherwise be a risk to the operator or other passengers in the automobile when the automobile is in motion. Furthermore, most states have enacted legislation requiring firearms to be encased during transport within an automobile.

Another concern for firearms, as well as for tools, equipment, ammunition and other valuable property, is that they can be considerably heavy. The weight of these items becomes an important consideration when an owner decides on an appropriate location to place them within an automobile. Despite their weight, such valuable property can also be fragile or otherwise susceptible to damage, misalignment or miscalibration if allowed to move about during transportation. This is particularly true of gun sights and scopes for firearms, especially when these items are transported within an automobile traveling over rough terrain or undergoing extreme maneuvering.

A wide variety of vehicle storage systems have been developed for providing storage for property including firearms, supplies and equipment. A system commonly known in industry is a container having one or more lockable compartments with sliding or hinged door panels for accessing the storage compartments.

Other systems use sliding drawer units adapted to fit within the rear storage area of a sport utility vehicle, or that attach to the bed of a pickup truck. Commonly known drawer guide systems have a complex system of drawer side pull-out rails at each side of a drawer with load-transmitting rollers mounted on the rails. A problem with these drawer units is that side-supporting drawer guide systems are subject to wear and breakage with excessive use, particularly when the drawers are used to support heavy firearms, supplies or other equipment. The motion of a moving vehicle will additionally cause the drawer guides to flex and bend, resulting in failure or unsatisfactory performance.

Some of these storage systems provide a mounting structure that enables the storage container to be secured to a surface within an automobile, such as with mounting plates affixed to the automobile which engage and lock into the body of the container. A common problem with storage systems of this type is that if the mounting system is readily detectable, it can be defeated by prying at the mounting locations. It is desirable to have a mount for a storage system that resists detection and being defeated by a would-be thief.

There are many known locking systems for securing storage containers. Keyed locks and combination locks are widely used. Most locking systems are located on the front or top of a storage container to provide ready access to a user. A problem is that the corresponding latch members for these types of locks is at or near the key hole or combination face. A thief would have similarly ready access to defeat a locking system that is located on the front of top of a storage container. Another problem exists in that a user could forget to lock the storage container after using it. The contents would be unsecured unless the user remembers to lock the container after each use.

Larger storage containers can be susceptible to flexing and otherwise distorting their shape under heavy load or due to the motion of a moving automobile, resulting in compromised structural integrity of the container, and compromised security for the contents stored within. Containers using drawer systems are particularly susceptible to failure if the container becomes sufficiently distorted as to bind or otherwise prevent the drawer from sliding freely. This problem can result simply by placing heavy items on top of the storage container, which in turn presses down onto a drawer within, preventing it from opening and closing properly. There is a need for a reinforced storage container that will retain its structural integrity under a heavy load or when subjected to motion.

It is also desirable to have a mounting structure for a storage system that enables an authorized user to easily remove the storage container from the automobile surface. A user may wish to remove the container from an automobile and use the container to transport valuable property from one location to another. For example, hunters or law enforcement agents may need to move their firearms, supplies and ammunition from their automobile to a hunting location or firing range. A user may also wish to relocate a storage container from one automobile to another. A problem with releasable mounting structures for commonly known storage systems is that they provide insufficient security once a primary locking system is defeated.

Many conventional storage systems are designed and marketed for installation and use in a particular model or type of vehicle, having dimensions that enable a proper fit within only that particular model or vehicle type. A user is typically prevented from transferring the storage system intended for one vehicle to another vehicle of differing dimensions, thus limiting the usefulness of the system.

In an increasingly competitive market for storage systems and devices, it is important that manufacturers of these systems and devices increase profitability and competitive advantage through optimization of value to buyers and reduction of manufacturing costs. It is desirable to produce storage systems and devices that offer an improvement over those currently available, providing an extended operating life, improved performance throughout their operating life with minimal wear and breakage, and storage systems and devices that can be economically constructed with a minimum of parts and construction costs to produce a high-quality product.

### BRIEF SUMMARY OF THE INVENTION

The above-described problems are solved and a technical advance achieved by the present storage system for transporting, protecting and storing valuable property in an automobile. Providing a storage system with improved features enabling transportability and protection of valuable property, including firearms and similarly heavy items, offers numerous advantages over traditional storage systems. The advantages stem mostly from simplification of construction using common materials and design features that minimize the number of working parts and extend the useful life of the storage system, which greatly contribute to performance and value to a user.

A storage system is disclosed having a locking storage container which can be secured to a mounting surface, such as an automobile interior, for transporting, protecting and storing valuable property. The storage system is primarily intended for firearms, tools and similarly heavy items. At least one drawer is received within an interior chamber of the locking container, each drawer being supported from below by several high-strength rollers housed within a low-profile base pan. The simplicity of construction, minimization of wear and breakage of moving parts, and improved capacity for supporting heavy drawer loads, particularly when the storage system is subjected to motion in a moving automobile, offer significant advances over the prior art. Alternate embodiments of the present invention provide for storage cases having at least two drawers, the two or more drawers being arranged in a side-by-side configuration, a stacked configuration with one drawer on top of another, or combination of side-by-side and stacked drawers.

Each drawer can be independently locked with primary and redundant locks, including a remote-controlled self-arming lock that secures the back of each drawer in a location inaccessible to an unauthorized user. Independent locks, in a system having multiple drawers, provides redundant levels of security—unauthorized access to one drawer will not enable access into the other drawer(s). Key-accessible locks, combination locks, and cargo paddle locks are examples of possible locks for this system, but the invention is not limited to these examples.

Anchor mounts are affixed on a mounting surface and engage the base pan in concealed locations along inside lower portions of the base pan under the container. A possible risk of theft is reduced in that the system of mounting is not visible from the outside once the storage container is secured to a mounting surface and the drawer is installed. An authorized user can unlock the drawer and remove it to access and disengage the anchor mounts, thereby removing and transporting storage container. The storage container and its contents can then be transported to another location and, if desired, mounted to another surface.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective view of a storage system of the present invention having two drawers, shown mounted within an automobile.

FIG. 2 is a perspective view of a storage system of the present invention having one drawer, showing the front of a storage container.

FIG. 3 a perspective view of a storage system of the present invention, showing the rear of a storage container.

FIG. 4 is a top-front perspective view of a storage system of the present invention, showing the drawer withdrawn from the container mainframe.

FIG. 5 is a cut-away front perspective view of a storage container mainframe of the present invention, showing details of internal elements.

FIG. 6 is a side elevation view of a storage system of the present invention, showing a drawer partially withdrawn from the container mainframe.

FIG. 7 is a partial side elevation view of a storage system of the present invention, showing details of drawer and roller interrelation.

FIG. 8 is a partial front elevation view of a storage system of the present invention, showing details of drawer and roller interrelation.

FIG. 9 is a partial front perspective view of a base pan of the present invention, showing details of a drawer roller and an anchor mount.

FIG. 10 is a partial plan view showing details of a rear drawer lock of the present invention, unlatched.

FIG. 11 is a partial plan view showing details of a rear drawer lock of the present invention, latched.

### DETAILED DESCRIPTION OF THE INVENTION

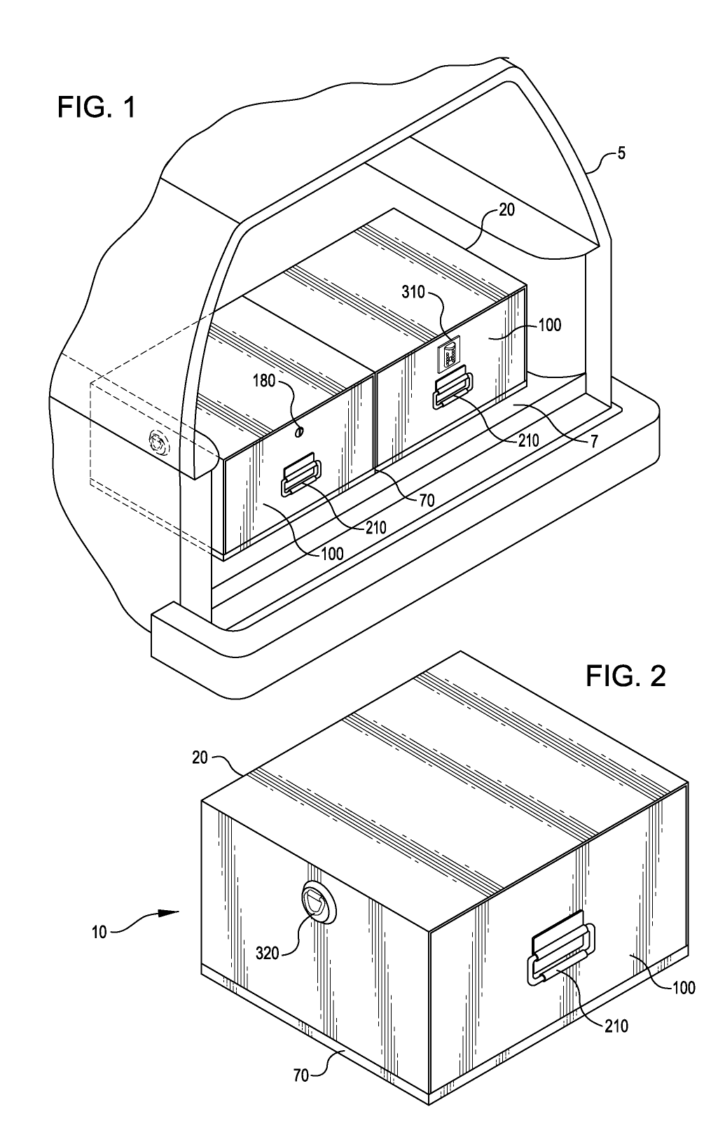

FIG. 1 shows a storage system of the present invention within the back of an automobile 5 affixed to a mounting surface 7. A mounting surface can be any surface with dimensions sufficient to accommodate the base area of the storage container 20. FIG. 1 shows an example of the present invention having a storage container 20 with a base pan 70 and two drawers 100 arranged side-by-side, each drawer 100 having a handle 210 and a front drawer lock 180. For purposes of illustration, the drawer 100 on the right side of FIG. 1 is shown with combination lock 310, of a touch-key combination type commonly know in industry, as an alternate example of a front drawer lock 180. It is preferable that a storage container 20 having multiple drawers 100 has a similar drawer lock 180 for each drawer 100. The drawers 100 are withdrawn outward from the rear of the automobile 5.

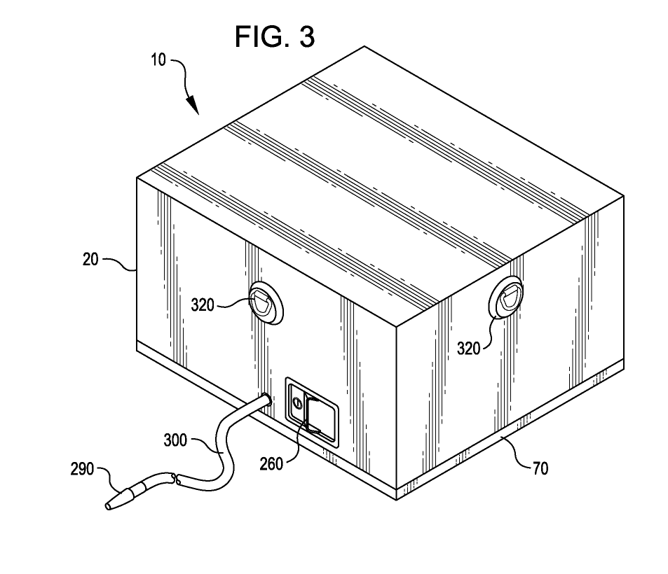

FIGS. 2 and 3 show perspective views of a storage system 10 of the present invention. FIG. 2 shows a front perspective view of the storage system 10 comprising a storage container 20, a single drawer 100 having a drawer handle 210, and a base pan 70. FIG. 3 shows a rear perspective view of the storage system 10 with the storage container 20 and base pan 70 as shown in FIG. 2, further comprising a paddle lock 260, as is commonly known in industry, and a power adapter 290 and power adapter cable 300 for supplying electrical power to an optional remote-controlled lock assembly (not shown). A cargo tie-down bracket 320, as is commonly known in industry, is shown mounted on the side and the rear of the storage container 20 for providing a means of redundantly or temporarily securing the storage container 20 to a mounting surface 7 by using rope, straps or cables, for example, to tie onto the tie-down bracket 320 and a secure location.

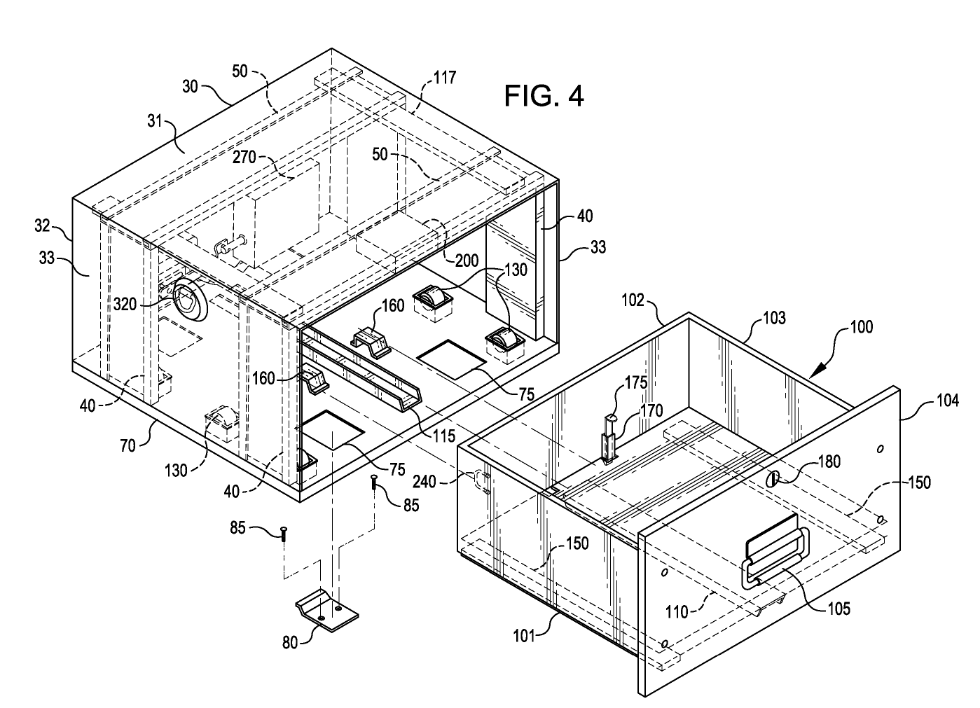

FIG. 4 is a top-front perspective view of a storage system of the present invention, showing a storage container 20 with a drawer 100 withdrawn from a container mainframe 30. The container mainframe 30 has a top member 31, a rear member 32, a pair of sidewall members 33, and a floor, which comprises a base pan 70, the combination of elements joined to each other to form an interior chamber. The container mainframe 30 can be made of any suitably hard material that resists wear and breakage, and is capable of being machined, molded, or otherwise fabricated to form a container that will receive a drawer 100. The storage system shown in FIG. 4 illustrates an example of the relationships of the various elements in a preferred embodiment of the present invention. The container mainframe 30 is shown with two vertical supports 40 on each sidewall member 33 and two horizontal supports 50 affixed to the inside of the top member 31, to provide strength and structural rigidity to the container mainframe 30. Two upper drawer supports 117 are aligned with the direction of drawer 100 travel and are affixed to the underside of the top member 31 of the container mainframe 30 at locations on the undersides of the horizontal supports 50.

An example of a storage system of the present invention comprises a container mainframe 30 that is preferably constructed of 100% aluminum 0.080. The container mainframe 30 can be formed of any hardened material, including, but not limited to, metals, hard plastics, fiberglass, and carbon fiber composites. Outer surfaces of the container mainframe 30 and drawer 100 are preferably treated with a two coat powder coat finish, although the surfaces may be finished with any possible material that adheres to the construction material, or left unfinished. The sidewall members 33 of the container mainframe 30 are connected to the top member 31, rear member 32 and base pan 70 using a plurality of rivets. The rivets are preferably closed end rivets.

The vertical supports 40 and the horizontal supports 50 within the container mainframe 30 are preferably formed as interior supports called top hats. Top hats are a one-piece construction of aluminum material bent mechanically, forming a cross-sectional flattened C in appearance, so that they form extremely strong supports. Once formed, the top hat supports are then placed vertically and horizontally along the interior of the container mainframe 30 and attached with rivets or other fasteners. A result of the use of top hat supports on the interior of the container mainframe 30 is that a storage container 20 so constructed allows significant cargo weight to be placed on the top of the storage container 20 without interfering with drawer 100 operation.

Also shown in FIG. 4 is an preferred example of a container mainframe 30 having a plurality of rollers recessed within a base pan 70 for engaging the drawer 100. The base pan 70 has four mounting apertures 75, which are openings through the base pan 70, that provide access to anchor mounts 80, which are affixed to a mounting surface 7 (as shown in FIG. 1) using fasteners 85. The anchor mounts 80 engage the base pan 70 along an edge of each mounting aperture 75. The anchor mounts 80 are preferably formed of a hardened material such as steel, but may be formed of, without limitation, heavy-gauge aluminum, hard plastics, or any composite materials that will withstand deformation and breakage under heavy load, and have a flange edge that enables positioning of the base pan 70 over the anchor mounts 80 and sliding the base pan 70 so that the anchor mounts 80 engage the base pan 70 along an edge of each mounting aperture 75. The container mainframe 30 and base pan 70 are preferably fabricated by punching, bending and welding to provide strength and durability. It should be obvious to one of skill in the art that a wide variety of fabrication means is possible, including, without limitation, cutting, molding, laminating, and the use of adhesives.

The drawer assembly 100 shown in FIG. 4 comprises a bottom panel 101 having a lower surface and an upper surface, a rear panel 102, a pair of drawer sidewalls 103, and a front panel 104, which in combination are joined together to define a storage compartment. The drawer assembly 100 further comprises a drawer handle assembly 105, which is preferably a spring-loaded steel drawer handle 210. Affixed to the lower surface of the bottom panel 101 is a drawer guide 110 that slidably engages a corresponding drawer guide channel 115 affixed on the base pan 70 within the container mainframe 30 and maintains alignment of the drawer along its range of travel within the container mainframe 30. Roller tracks 150 are shown affixed to lower surface of the bottom panel 101, extending longitudinally in the direction of drawer travel, that engage the rollers 130. Roller tracks 150 can be formed of any material having a low friction coefficient that will enable smooth travel of the drawer 100 over the rollers 130. The drawer 100 further comprises a drawer release latch 170 mounted on the inside rear of the drawer rear panel 102. The drawer release latch 170 preferably has a downwardly biased drawer release latch handle 175, the latch engaging the drawer 100 and a drawer stop 160 on the container mainframe 30, the drawer release latch 170 positionable in a first latching position, and in a second release position, whereby the drawer 100 is prevented from being fully withdrawn from the interior chamber with the drawer release latch 170 in the first latching position, and the drawer 100 is removable from the interior chamber with the drawer release latch 170 in the second release position. It is preferred that the drawer 100 is lined with a drawer liner (not shown) on the upper surface of the bottom panel 101 with a shock absorbing padded material, such as carpet material or a high-density foam commonly known in industry, and compartment dividers (not shown) for providing added protection to drawer contents.

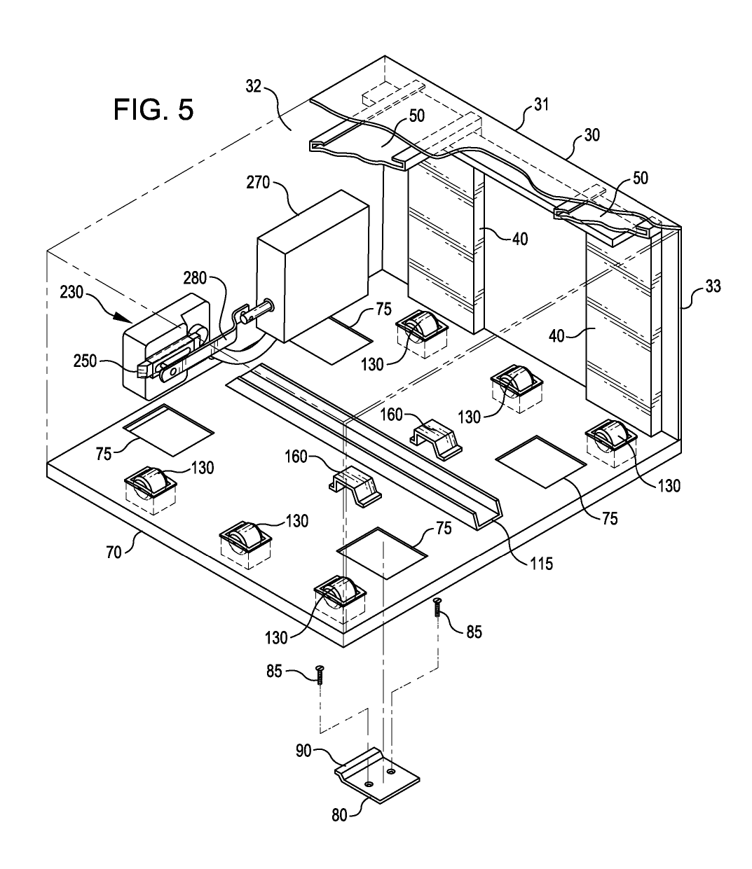

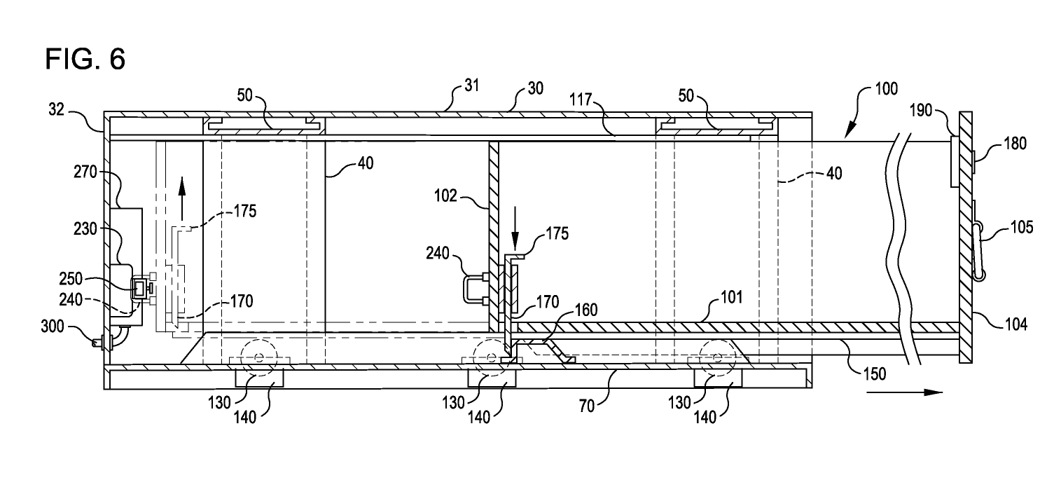

FIG. 5 is a cut-away front perspective view of a storage container mainframe 30 of the present invention, showing details of internal elements. The container mainframe 30 is shown having a base pan 70 supporting a plurality of rollers 130, four mounting apertures 75 and an example corresponding anchor mount 80 with anchor mount flange 90, drawer stops 160, and a drawer guide channel 115, along with vertical supports 40 affixed to a sidewall member 33 and horizontal supports 50 affixed to a top member 31 as previously described. Also shown is a rear door lock assembly 230 having a rear drawer lock latch 250 affixed to the inside rear member 32. The rear drawer lock latch 250 engages a rear drawer lock catch 240 (as shown in FIGS. 4 and 6) located in a corresponding location on the rear panel 102 of the drawer 100 as shown in FIG. 4. Also shown in FIG. 5 is a remote-controlled lock actuator 270 affixed to the rear member 32 that communicates with the rear drawer lock assembly 230 by a lock linkage 280.

FIG. 6 is a side elevation view of a storage system of the present invention, showing a drawer 100 partially withdrawn from the container mainframe 30. Rollers 130 are retained in roller housings 140 which are in turn affixed to the base pan 70. The rollers 130 engage a roller track 150 affixed to the lower surface of the bottom panel 101 of the drawer 100. An upper drawer support 117 is affixed to the upper inside of the container mainframe 30 on a lower surface of the top member 31 and engages the top edges of the drawer sidewalls and the top edge of the rear panel 102 to maintain a level horizontal position of the drawer 100 through its range of travel within the container mainframe 30. FIG. 6 shows a side view of a drawer 100 front panel 104 having a drawer handle assembly 105 and a front drawer lock assembly 180 having a corresponding front drawer latch 190, which releasably engages a latch receiver (not shown). Also shown in FIG. 6 is a drawer release latch 170 with a drawer release latch handle 175 affixed to the drawer rear panel 102 that is in contact with a drawer stop 160, which is affixed to the base pan 70. With the drawer release latch 170 in its normally downward position, accomplished by downward-biased spring element (not shown), the drawer release latch 170 contacts the drawer stop 160 preventing further outward travel of the drawer 100 until the drawer release latch 170 is raised, enabling it to bypass the drawer stop 160. The rear door lock assembly 230 with a lock catch 240 is shown affixed to the rear panel 102 of the drawer 100 and is shown disengaged from the rear drawer lock latch 250 with the drawer 100 partially withdrawn from the container mainframe 30 in a first position, and with the rear door catch 240 engaged and retained by the rear drawer lock latch 250 with the drawer 100 in a fully closed position within the container mainframe 30. A remote-controlled lock actuator 270 is located to communicate with the rear door lock assembly 230, and is shown with a power adapter cable 300 at the container mainframe 30 rear member 32. An example of the previously described top hat vertical members 40 and horizontal members 50, shown in cross-section, are shown making up the structural supports for the container mainframe 30.

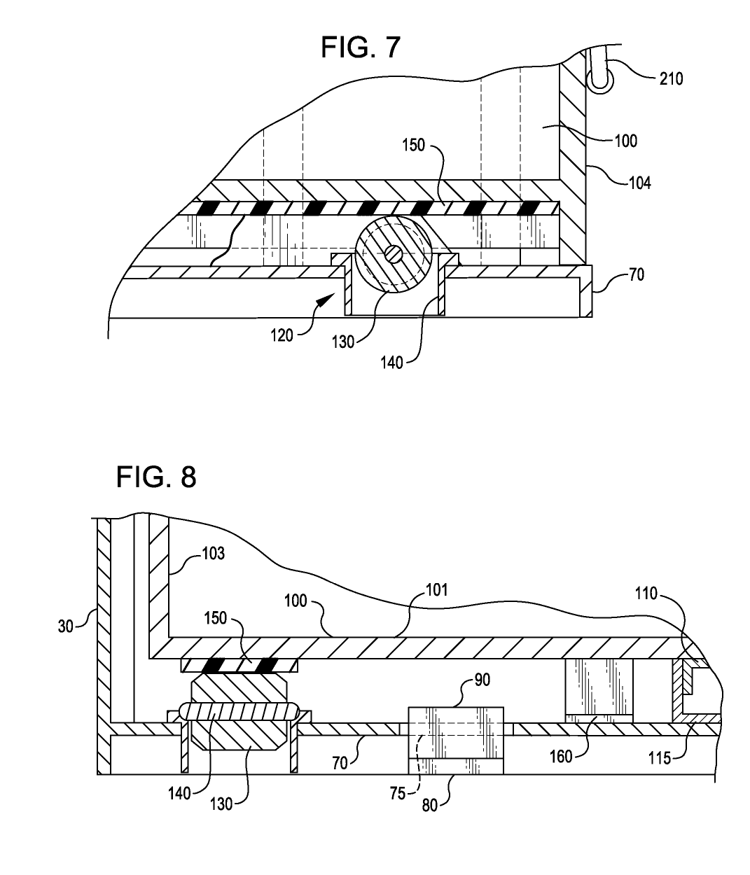

FIG. 7 shows a detailed side view of the drawer 100 and roller 130 engagement in an example of the present invention. A preferred roller assembly 120 for the present invention is manufactured by KieTek Intl., which provides a barrel-shaped steel roller rotatably retained within a roller housing 140, each having a 450 pound weight capacity. Alternate rollers assemblies 120 can include ball rollers and single-roller structures that provide sufficiently smooth travel of a drawer 100. While a single roller 130 element supporting the underside of a drawer 100 in conjunction with upper drawer supports 117 maintaining the drawer's horizontal positioning and a drawer guide 110 could provide a workable drawer, a preferred storage system is constructed using a plurality of rollers 130 arranged in locations along the base pan 70 corresponding to the location of roller tracks 150 running the length of each drawer. The roller assembly 120, as shown in FIG. 7, is mounted within an opening formed in the base pan 70. The drawer 100 is supported on the roller 130, which engages a roller track 150 affixed to the lower surface of the drawer 100. The base pan 70 has edges formed by bending aluminum sheet stock perpendicular to the surface of the base pan 70, the edges providing sufficient clearance for the roller assemblies 120 between the base pan 70 and the mounting surface 7 (shown in FIG. 1). The rollers 130 of the present invention provide a more stable environment for the drawers 100 to move in and out of the container mainframe 30. Further, the rollers 130 provide the advantage of fewer moving parts, which provides additional value to the longevity and performance of the storage system by minimizing wear, maintenance and breakage issues associated with drawer systems existing in the prior art. In addition, this use of the rollers 130 also facilitates more usable drawer space than currently known in the art by eliminating the added side bulk of existing side-mounted drawer roller guides.

FIG. 8 shows a second detailed front view of the drawer 100 and roller 130 engagement in an example of the present invention as described previously. FIG. 8 also shows the relative positions of a roller 130 with respect to an anchor mount 80 and anchor mount flange 90 engaged within a mounting aperture 75, a drawer stop 160 affixed to the base pan 70, and a partial cross-sectional view of the interrelationship of the drawer guide 110 affixed to the lower surface of the bottom panel 101 of the drawer 100 and the drawer guide channel 115 affixed to the base pan 70.

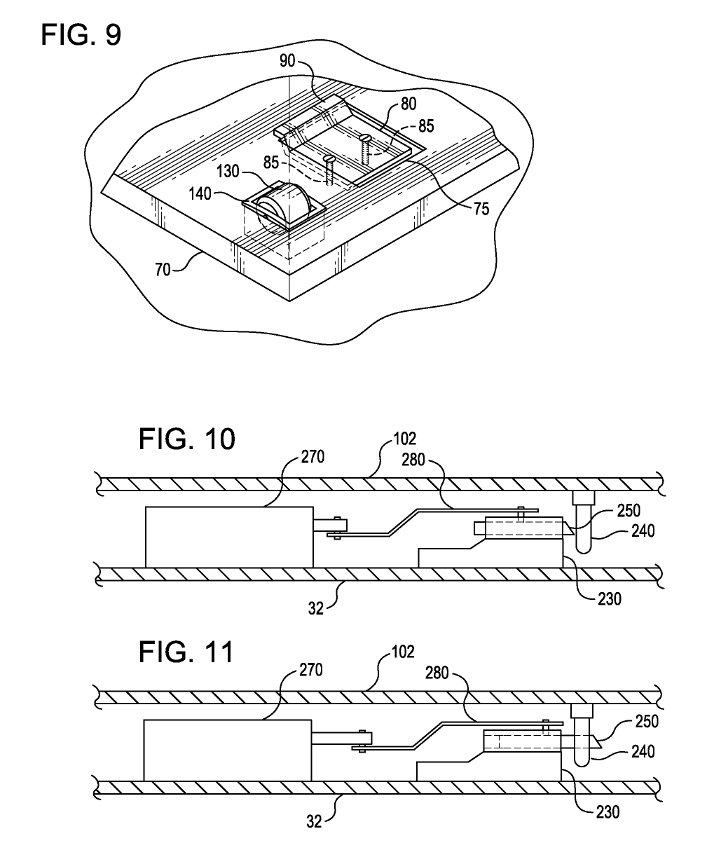

FIG. 9 shows a perspective view of a section of a base pan 70 detailing a roller 130 and roller housing 140 mounted on the base pan 70 and the engagement of an anchor mount 80 with its mount flange 90 engaging an edge of a mounting aperture 75.

FIGS. 10 and 11 illustrate a partial plan view showing details of a rear drawer lock of the present invention, unlatched and latched, respectively. A remote-controlled lock actuator 270 is mounted to the rear member 32 of the container mainframe 30 in proximity to the rear drawer lock assembly 230 and communicates with the a lock linkage 280 that mechanically withdraws and engages the lock latch 250 with the rear drawer lock catch 240. An example of a remote-controlled lock actuator 270 is an electrically powered solenoid and associated electronic circuitry that responds to commands received by a radio-frequency transmitting remote control device to mechanically release the rear drawer lock catch 240 from the drawer lock latch 250. A remote-controlled lock actuator 270 may be powered internally as with battery power, or is preferably powered by the battery of an automobile 5 in which the storage system is installed. The power adapter cable 300 and power adapter 290 (shown in FIG. 3) are operationally connected between the remote-controlled lock actuator 270 and an external power source such as the battery of an automobile, for example. A timing circuit, as is commonly understood in the art of electronic lock actuators, is provided that automatically causes the remote-controlled lock actuator 270 to engage the lock latch 250 with the rear drawer lock catch 240 after a set time duration. Automatic arming of the locking system provides an added measure of security should a user of the storage system fail to manually lock the drawer 100.

In an optional embodiment of the present invention (as shown in FIG. 1), there are at least two base pans affixed to the bottom of the container mainframe, thereby allowing for two or more drawers to be used in a side-by-side configuration. If at least two pans are used, there is an additional frame located between each drawer storage compartment. This framed construction protects valuable property located in a second drawer in the event that a first drawer's security is compromised. In an alternate configuration (not shown), at least one additional base pan is mounted to an upper surface of a lower container mainframe, thereby providing for at least two drawers stacked one on top of another.

### INDUSTRIAL APPLICABILITY

The present invention has applicability to the field of storage systems and devices, and more particularly to a storage system for transporting, protecting and storing valuable property in an automobile.

In compliance with statute, the invention has been described in language more or less specific as to storage systems and devices. It is to be understood, however, that the invention is not limited to the specific means or features shown or described, since the means and features shown or described comprise preferred ways of putting the invention into effect.

Additionally, while this invention is described in terms of being used for transporting, protecting and storing valuable property in an automobile, it will be readily apparent to those skilled in the art that the invention can be adapted to other uses for other forms of storage and security systems and devices as well, and therefore the invention should not be construed as being limited to storage systems as used in automobiles. The invention is, therefore, claimed in any of its forms or modifications within the legitimate and valid scope of the appended claims, appropriately interpreted in accordance with the doctrine of equivalents.

What is claimed is:

1. A storage system for transporting, protecting and storing valuable property, the system comprising:
(a) a container mainframe comprising a top member, a rear member, a pair of sidewall members and a base pan, which in combination define an interior chamber;
(b) at least one drawer located within the interior chamber, the drawer comprising a bottom panel having a lower surface and an upper surface, a rear panel, a pair of drawer sidewalls and a front panel, which in combination define a storage compartment;
(c) at least one roller engaging the first lower surface of the drawer bottom panel and the first surface of the base pan, whereby the drawer is supported by the at least one roller and the drawer travels within the interior chamber; and
(d) at least one drawer lock for securing the drawer within the interior chamber.

2. The storage system of claim 1, wherein the base pan is affixed to the container mainframe rear member and side members, the base pan further comprising at least one aperture.

3. The storage system of claim 2, further comprising at least one mount engaging the base pan and a mounting surface, whereby the base pan and container mainframe are affixed to the mounting surface.

4. The storage system of claim 3, wherein the at least one mount releasably engages the base pan, whereby the base pan and the container mainframe are removable from the mounting surface.

5. The storage system of claim 1, wherein the at least one drawer lock is a combination-actuated lock.

6. The storage system of claim 1, further comprising a remote-controlled lock actuator communicating with the drawer lock, whereby the drawer is lockable and unlockable by a user from a remote location.

7. The storage system of claim 1, wherein the at least one drawer lock engages the drawer at a location rearward of the front panel.

8. The storage system of claim 7, wherein the at least one drawer lock engages the drawer at a location on the rear panel.

9. The storage system of claim 1, further comprising a roller housing affixed to the floor and retaining the at least one roller, and the drawer bottom panel further comprising at least one roller track affixed to the lower surface, whereby the roller engages the roller track.

10. The storage system of claim 1, wherein the at least one drawer further comprises a drawer release latch engaging the drawer and a drawer stop on the container mainframe, the release latch positionable in a first latching position, and in a second release position, whereby the drawer is prevented from being fully withdrawn from the interior chamber with the drawer release latch in the first latching position, and the drawer is removable from the interior chamber with the drawer release latch in the second release position.

11. The storage system of claim 1, further comprising at least one tie-down bracket affixed to the container mainframe.

12. A storage system for transporting, protecting and storing valuable property, the system comprising:
(a) a container mainframe comprising a top member, a rear member, a pair of sidewall members and a floor, which in combination define an interior chamber;
(b) at least one drawer located within the interior chamber, the drawer comprising a bottom panel having a lower surface and an upper surface, a rear panel, a pair of drawer sidewalls and a front panel, which in combination define a storage compartment;
(c) at least one drawer lock for securing the drawer within the interior chamber; and
(d) a remote-controlled lock actuator communicating with the drawer lock, whereby the drawer is lockable and unlockable by a user from a remote location.

13. The storage system of claim 12, wherein the remote-controlled lock actuator further comprises a self-locking timer, whereby the drawer is automatically lockable within a set period of time.

14. The storage system of claim 12, wherein the remote-controlled lock actuator further comprises an internal electrical power source.

15. The storage system of claim 12, wherein the remote-controlled lock actuator further comprises an external electrical power source adapter.

16. The storage system of claim 12, wherein the at least one drawer lock engages the drawer at a location rearward of the front panel.

17. The storage system of claim 16, wherein the at least one drawer lock engages the drawer at a location on the rear panel.

18. The storage system of claim 16, further comprising at least one mount engaging the container mainframe floor and a mounting surface, whereby the container mainframe is affixed to the mounting surface.

19. The storage system of claim 18, wherein the at least one mount releasably engages the container mainframe floor, whereby the container mainframe is releasable from the mounting surface.

20. A storage system for transporting, protecting and storing valuable property in an automobile, the system comprising:
(a) a container mainframe comprising a top member, a rear member, a pair of sidewall members, at least one horizontal support member, and at least one vertical support member;
(b) a base pan, further comprising a first surface and a second surface, at least one aperture between the first surface and the second surface, the first surface being affixed to the container mainframe rear member and side members, which in combination define an interior chamber;
(c) at least one anchor mount securable on a mounting surface within an automobile, the anchor mount releasably engaging the base pan within the aperture, whereby the base pan and the container mainframe are removable from the mounting surface;
(d) at least one drawer located within the interior chamber, the drawer comprising at least one drawer guide, and a bottom panel having a lower surface and an upper surface, a rear panel, a pair of drawer sidewalls and a front panel, which in combination define a storage compartment;
(e) a plurality of rollers retained within the base pan and engaging the first lower surface of the drawer bottom panel, whereby the drawer is supported by the plurality of rollers and the drawer travels within the interior chamber;
(f) at least one rear drawer lock for securing the drawer within the interior chamber, the rear drawer lock located at the container mainframe rear member, whereby the drawer lock engages the drawer at a location on the rear panel;
(g) a remote-controlled lock actuator located within the container mainframe and communicating with the drawer-engaging lock, whereby the drawer is lockable and unlockable by a user from a remote location;
(h) a remote control communicating with the remote-controlled lock actuator; and
(i) at least one redundant lock for securing the drawer within the interior chamber.
